(19) United States
(12) Patent Application Publication
(10) Pub. No.: US 2021/0357830 A1
(43) Pub. Date: Nov. 18, 2021

(54) SYSTEM, INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Wataru KYOCHIKA, Toyota-shi (JP); Riho MATSUO, Nagoya-shi (JP); Kenta MIYAHARA, Toyota-shi (JP); Ryotaro KAKIHARA, Nagoya-shi (JP)

(73) Assignee: TOYOTA JIDOSHA KABUSHIKI KAISHA, Toyota-shi (JP)

(21) Appl. No.: 17/319,323

(22) Filed: May 13, 2021

(30) Foreign Application Priority Data
May 14, 2020 (JP) 2020-085060

(51) Int. Cl. G06Q 10/06; G06F 16/23; G06Q 50/26; G06T 7/62; G01C 21/00; G01C 21/34

(52) U.S. Cl. CPC G06Q 10/06311; G06F 16/2379; G01C 21/343; G06T 7/62; G01C 21/3841; G06Q 50/26

(57) ABSTRACT

A system according to a first aspect of the present disclosure is a system including a plurality of user terminals associated with a plurality of users, and an information processing apparatus configured to manage a plurality of collection vehicles for collecting garbage, where each user terminal transmits, to the information processing apparatus, garbage information including the amount of garbage that an associated user wants collected in a predetermined region, and the information processing apparatus calculates the total amount of garbage that is desired to be collected in the predetermined region, based on the garbage information received from each user terminal, and determines at least one dispatch vehicle to be dispatched to the predetermined region from among the plurality of collection vehicles, based on the total amount of garbage that is calculated.

### CROSS REFERENCE TO THE RELATED APPLICATION

This application claims the benefit of Japanese Patent Application No. 2020-085060, filed on May 14, 2020, which is hereby incorporated by reference herein in its entirety.

### BACKGROUND

### Technical Field

The present disclosure relates to a system, an information processing apparatus, and an information processing method.

### Description of the Related Art

Japanese Patent Laid-Open No. 2001-163403 discloses a garbage collection vehicle operation management system including a container apparatus that is installed at a garbage collection point and that is used to collect garbage, and a garbage collection vehicle that collects garbage from the container apparatus. In the garbage collection vehicle operation management system disclosed in Japanese Patent Laid-Open No. 2001-163403, the container apparatus, a collection vehicle information apparatus, and a center apparatus are connected by a line. The collection vehicle information apparatus includes computation means that computes a remaining capacity of the garbage collection vehicle, position collection means that collects position information on the garbage collection vehicle, and transmission means that transmits the remaining capacity and the position information to the center apparatus. Furthermore, the center apparatus includes calculation means that calculates information about a next collection point at which to perform collection, based on a collection amount, the position information, and the remaining capacity.

### SUMMARY

An object of the present disclosure is to provide a technology for realizing efficient dispatch of collection vehicles for collecting garbage.

A system according to a first aspect of the present disclosure is

a system including a plurality of user terminals associated with a plurality of users, and an information processing apparatus configured to manage a plurality of collection vehicles for collecting garbage, where

each user terminal transmits, to the information processing apparatus, garbage information including an amount of garbage that an associated user wants collected in a predetermined region, and

the information processing apparatus

calculates a total amount of garbage that is desired to be collected in the predetermined region, based on the garbage information received from each user terminal, and

determines at least one dispatch vehicle to be dispatched to the predetermined region from among the plurality of collection vehicles, based on the total amount of garbage that is calculated.

An information processing apparatus according to a second aspect of the present disclosure is

an information processing apparatus that manages a plurality of collection vehicles for collecting garbage, the information processing apparatus including a controller comprising at least one processor configured to:

acquire garbage information including an amount of garbage that each of a plurality of users wants collected in a predetermined region,

calculate a total amount of garbage that is desired to be collected in the predetermined region, based on the garbage information on each of the plurality of users, and

determine at least one dispatch vehicle to be dispatched to the predetermined region from among the plurality of collection vehicles, based on the total amount of garbage that is calculated.

An information processing method according to a third aspect of the present disclosure is

an information processing method performed by a computer that manages a plurality of collection vehicles for collecting garbage, the information processing method including:

acquiring garbage information including an amount of garbage that each of a plurality of users wants collected in a predetermined region;

calculating a total amount of garbage that is desired to be collected in the predetermined region, based on the garbage information on each of the plurality of users; and

determining at least one dispatch vehicle to be dispatched to the predetermined region from among the plurality of collection vehicles, based on the total amount of garbage that is calculated.

According to the present disclosure, collection vehicles for collecting garbage may be efficiently dispatched.

### BRIEF DESCRIPTION OF THE DRAWINGS

FIG. 1 is a diagram illustrating a schematic configuration of a garbage collection system;

FIG. 2 is a diagram illustrating an example of functional configurations of a user terminal, a management server, and an on-board terminal forming the garbage collection system;

FIG. 3 is a diagram illustrating an example of a table structure of garbage information that is stored in a garbage information database according to a first embodiment;

FIG. 4 is a diagram illustrating an example of a table structure of collection vehicle information that is stored in a collection vehicle information database;

FIG. 5 is a first sequence diagram illustrating a flow of information and processes of the garbage collection system according to the first embodiment;

FIG. 6 is a second sequence diagram illustrating a flow of information and processes of the garbage collection system according to the first embodiment;

FIG. 7 is a diagram illustrating an example of a table structure of garbage information that is stored in a garbage information database according to a second embodiment;

FIG. 8 is a third sequence diagram illustrating a flow of information and processes of a garbage collection system according to the second embodiment; and

FIG. 9 is a fourth sequence diagram illustrating a flow of information and processes of the garbage collection system according to the second embodiment.

### DESCRIPTION OF THE EMBODIMENTS

A system according to a first aspect of the present disclosure is a system including a plurality of user terminals associated with a plurality of users, and an information processing apparatus configured to manage a plurality of collection vehicles for collecting garbage. In the system according to the first aspect of the present disclosure, each user terminal transmits, to the information processing apparatus, garbage information including the amount of garbage that an associated user wants collected in a predetermined region. The amount of garbage here may be the size of garbage, the weight of garbage, the quantity of garbage, or a combination of such values. The information processing apparatus calculates the total amount of garbage that is desired to be collected in the predetermined region, based on the garbage information received from each user terminal. Then, the information processing apparatus determines at least one dispatch vehicle to be dispatched to the predetermined region from among the plurality of collection vehicles, based on the total amount of garbage that is calculated.

As described above, with the system according to the first aspect of the present disclosure, at least one dispatch vehicle may be determined based on the total amount of garbage that is desired to be collected in the predetermined region. Accordingly, a collection vehicle for collecting garbage may be efficiently dispatched.

In the following, specific embodiments of the present disclosure will be described with reference to the drawings. Dimensions, materials, shapes, relative positions and the like of structural components described in the present embodiments are not intended to limit the technical scope of the present disclosure unless stated otherwise.

### First Embodiment

(Outline of System)

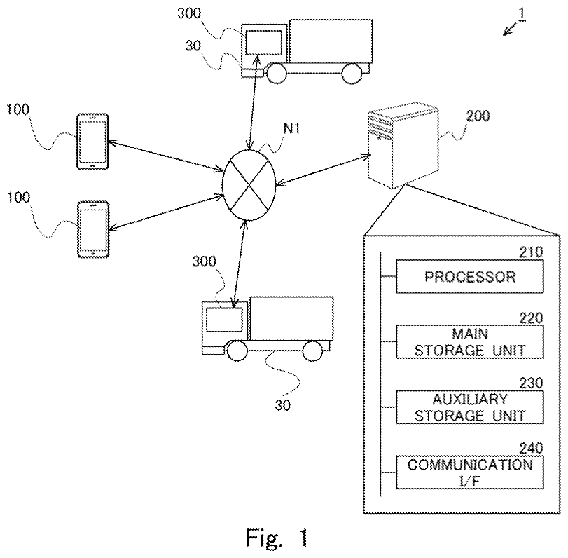

A garbage collection system 1 according to a present embodiment will be described with reference to FIG. 1. FIG. 1 is a diagram illustrating a schematic configuration of the garbage collection system 1. The garbage collection system 1 includes a plurality of user terminals 100, a management server 200, and a plurality of on-board terminals 300.

Each user terminal 100 is a terminal that is associated with corresponding one of a plurality of users. As the user terminal 100, a computer or a mobile data terminal that is used by the user may be cited as an example. The amount of garbage that the user associated with the user terminal 100 wants collected in a predetermined region is input to the user terminal 100 by the user. The user may alternatively be an individual who wants garbage to be collected. The user may alternatively be a household, an office or the like that wants garbage to be collected. Moreover, the predetermined region is a target region where a collection vehicle is to collect garbage that is desired by a plurality of users to be collected. For example, the predetermined region is a district that is set in advance as a target of garbage collection by a collection vehicle.

Each on-board terminal 300 is a terminal that is mounted on corresponding one of a plurality of collection vehicles 30. Each on-board terminal 300 provides various pieces of information to an occupant on board the collection vehicle 30. Additionally, the on-board terminal 300 is not limited to a terminal that is integrally mounted on corresponding one of the plurality of collection vehicles 30. For example, a mobile data terminal that is carried by an occupant on board the collection vehicle 30 may function as the on-board terminal 300.

The management server 200 is a server that manages the plurality of collection vehicles for collecting garbage. The management server 200 determines at least one collection vehicle 30 (hereinafter also referred to as “dispatch vehicle 30”) that is to be dispatched to the predetermined region to collect garbage from among the plurality of collection vehicles 30 managed by the management server 200. The management server 200 includes a computer including a processor 210, a main storage unit 220, an auxiliary storage unit 230, and a communication interface (communication I/F) 240. The processor 210 is a central processing unit (CPU) or a digital signal processor (DSP), for example. The main storage unit 220 is a random access memory (RAM), for example. The auxiliary storage unit 230 is a read only memory (ROM), for example. Furthermore, the auxiliary storage unit 230 is a hard disk drive (HDD) or a disk recording medium such as a CD-ROM, a DVD disc or a Blu-ray disc, for example. The auxiliary storage unit 230 may alternatively be a removable medium (a removable storage medium). As the removable medium, an USB memory or an SD card may be cited as an example. The communication I/F 240 is a local area network (LAN) interface board or a wireless communication circuit for wireless communication, for example.

The auxiliary storage unit 230 of the management server 200 stores an operating system (OS), various programs, various information tables and the like. Furthermore, various functions as described below may be implemented by the processor 210 of the management server 200 loading programs stored in the auxiliary storage unit 230 into the main storage unit 220 and executing the programs. However, one or some or all of the functions of the management server 200 may alternatively be implemented by a hardware circuit such as an ASIC or an FPGA. Additionally, the management server 200 does not necessarily have to be implemented in a single physical configuration, and may be formed by a plurality of computers that cooperate with each other. Note that the management server 200 according to present embodiment corresponds to “information processing apparatus” according to a second aspect of the present disclosure.

In the garbage collection system 1, each user terminal 100, the management server 200, and each on-board terminal 300 are interconnected via a network N1. As the network N1, a wide area network (WAN), which is a worldwide public communication network such as the Internet, or a mobile communication network for mobile phones may be adopted, for example.

(System Configuration)

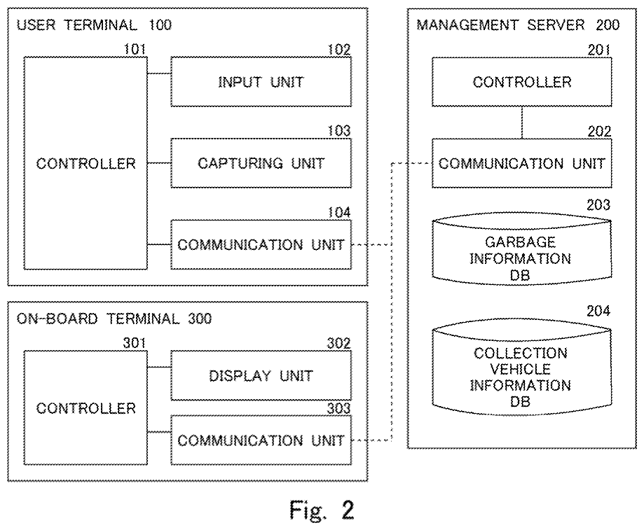

Next, functional configurations of the user terminal 100, the management server 200, and the on-board terminal 300 forming the garbage collection system 1 according to the present embodiment will be described with reference to FIG. 2. FIG. 2 is a diagram illustrating an example of functional configurations of the user terminal 100, the management server 200, and the on-board terminal 300 forming the garbage collection system 1.

(User Terminal)

The user terminal 100 includes a controller 101, an input unit 102, a capturing unit 103, and a communication unit 104. The controller 101 includes a function of performing arithmetic processing to control the user terminal 100. The controller 101 may be implemented by a processor of the user terminal 100. The communication unit 104 includes a function of connecting the user terminal 100 to the network N1. The communication unit 104 may be implemented by a communication I/F of the user terminal 100.

The input unit 102 includes a function used by a user associated with the user terminal 100 to input various pieces of information to the user terminal 100. The input unit 102 may be implemented by a keyboard, a touch panel or the like of the user terminal 100. The user inputs, to the input unit 102, information about the amount of garbage that the user wants collected in the predetermined region. The information about the amount of garbage that is input by the user is information about the size, the weight or the quantity of garbage, or information about a combination thereof. Furthermore, for example, the number of garbage bags and the capacity of each garbage bag may be input as the information about the amount of garbage. Alternatively, the size or the weight of an object that the user wants collected as garbage may be input as the information about the amount of garbage. The controller 101 acquires the amount of garbage that the user wants collected in the predetermined region, based on the information about the amount of garbage input to the input unit 102. Furthermore, the controller 101 generates garbage information based on the acquired amount of garbage. Then, the controller 101 transmits the garbage information to the management server 200 via the communication unit 104.

The capturing unit 103 includes a function of inputting a captured image or moving image to the user terminal 100. The capturing unit 103 may be implemented by a camera of the user terminal 100. The user may capture the garbage by the capturing unit 103, instead of performing input to the input unit 102. In this case, the controller 101 acquires the amount of garbage that the user wants collected in the predetermined region, based on the image or the moving image of the garbage captured by the capturing unit 103. A known method may be adopted as a method performed by the controller 101 to acquire the volume (the size) of the garbage based on the image or the moving image captured by the capturing unit 103. For example, the controller 101 acquires the volume of the garbage by measuring the length of the garbage based on the image or the moving image captured by the capturing unit 103. Furthermore, at this time, the user terminal 100 may acquire information about the type of the garbage based on input to the input unit 102 performed by the user. The user terminal 100 acquires the weight of the garbage that the user wants collected in the predetermined region, based on the weight per unit volume of garbage that is associated in advance with the type of the garbage. Furthermore, for example, the user terminal 100 may estimate the weight of the garbage by image recognition on the image of the garbage captured by the capturing unit.

(Management Server 200)

The management server 200 includes a controller 201, a communication unit 202, a garbage information database (a garbage information DB) 203, and a collection vehicle information database (a collection vehicle information DB) 204. The communication unit 202 includes a function of connecting the management server 200 to the network N1. The communication unit 202 may be implemented by the communication I/F 240 of the management server 200. The controller 201 includes a function of performing arithmetic processing to control the management server 200. The controller 201 may be implemented by the processor 210 of the management server 200.

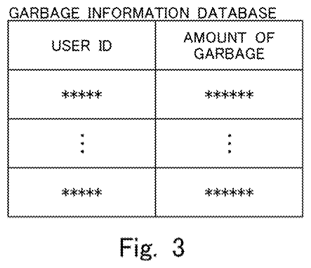

The garbage information DB 203 is a database that stores the garbage information. The garbage information DB 203 may be implemented by the auxiliary storage unit 230 of the management server 200. The controller 201 receives the garbage information from each user terminal 100 by the communication unit 202, and stores the garbage information in the garbage information DB 203. FIG. 3 is a diagram illustrating an example of a table structure of the garbage information that is stored in the garbage information DB 203 according to the present embodiment. As illustrated in FIG. 3, the table for the garbage information includes a user ID field and a garbage amount field. An identifier for specifying each user transmitting the garbage information is input in the user ID field. The identifier for specifying the user is included in the garbage information that is transmitted by the user terminal 100. Furthermore, information about the amount of garbage that each user transmitting the garbage information wants collected in the predetermined region is input in the garbage amount field.

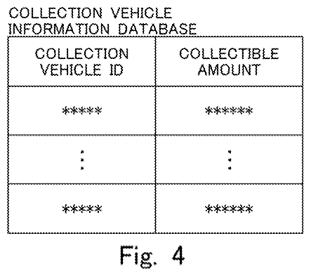

The collection vehicle information DB 204 is a database that stores collection vehicle information about the plurality of collection vehicles 30 managed by the management server 200. The collection vehicle information DB 204 may be implemented by the auxiliary storage unit 230 of the management server 200. The collection vehicle information is stored in advance in the collection vehicle information DB 204. For example, the collection vehicle information is input by an administrator managing the management server 200. FIG. 4 is a diagram illustrating an example of a table structure of the collection vehicle information that is stored in the collection vehicle information DB 204. As illustrated in FIG. 4, the table for the collection vehicle information includes a collection vehicle ID field and a collectible amount field. An identifier for identifying each collection vehicle 30 is input in the collection vehicle ID field. Information about the amount of garbage that each collection vehicle 30 is able to collect is input in the collectible amount field. As the information about the amount of garbage that can be collected, the volume or the weight of garbage that each collection vehicle 30 is capable of collecting is input, for example. Furthermore, both the volume and the weight of garbage that can be collected by each collection vehicle 30 may be input as the information about the amount of garbage that can be collected, for example.

The controller 201 calculates the total amount of garbage that is desired to be collected in the predetermined region (hereinafter also referred to as “the total amount of garbage in the predetermined region”), based on the garbage information that is received from each user terminal 100 and stored in the garbage information DB 203. People who want garbage to be collected in the predetermined region possibly include people who do not use the garbage collection system 1 and people other than users transmitting the garbage information by the user terminals 100. In this case, the total amount of garbage in the predetermined region is an amount including the total amount of garbage that people, in the predetermined region, other than users transmitting the garbage information (hereinafter such people may also be referred to simply as “people other than the users”) want collected. Accordingly, the controller 201 calculates, as the total amount of garbage in the predetermined region, a sum of the total amount of garbage that users transmitting the garbage information want collected in the predetermined region and the total amount of garbage that people other than the users want collected. At this time, the total amount of garbage that people other than the users want collected may be calculated based on a record of garbage collection in the predetermined region. For example, the total amount of garbage that people other than the users want collected may be calculated by multiplying an average value of the amount of garbage per person that is collected at one time, in the record of garbage collection, by a number that is obtained by subtracting the number of users transmitting the garbage information from the total number of persons who want garbage to be collected in the predetermined region. The management server 200 may thus grasp the total amount of garbage that is to be collected by the collection vehicle 30 in the predetermined region.

Moreover, the controller 201 generates incentive information indicating an incentive that is given to a user who transmits the garbage information. Then, the controller 201 transmits the incentive information, via the communication unit 202, to the user terminal 100 that is associated with the user transmitting the garbage information. As the incentive that is given to a user who transmits the garbage information, an electronic coupon or points may be cited, for example. The incentive that is given to a user who transmits the garbage information may alternatively be a discount on a fee that the user is to pay for garbage to be collected. When an incentive is given to a user who transmits the garbage information, transmission of the garbage information may be encouraged. Accordingly, a greater amount of garbage information may be collected compared with a case where no incentive is given to users for transmission of the garbage information. As a result, the controller 201 may calculate the total amount of garbage in the predetermined region based on the garbage information from a greater number of users. The controller 201 is thereby enabled to highly accurately calculate the total amount of garbage in the predetermined region.

The controller 201 determines at least one dispatch vehicle 30 based on the total amount of garbage in the predetermined region that is calculated. At this time, the controller 201 determines, as the dispatch vehicle 30, at least one collection vehicle 30 that is suitable for collecting the garbage in the predetermined region, based on the collectible amount of each collection vehicle 30 according to the collection vehicle information that is stored in the collection vehicle information DB 204. For example, the controller 201 determines the at least one dispatch vehicle 30 such that the collectible amount of one dispatch vehicle or the sum of the collectible amount of a plurality of dispatch vehicles is equal to or greater than the calculated total amount of garbage and such that a difference between the two values is made as small as possible. This may prevent unnecessary dispatch of collection vehicles. Furthermore, the controller 201 transmits, via the communication unit 202, instruction information instructing collection of garbage in the predetermined region, to the on-board terminal 300 of the at least one dispatch vehicle 30 that is determined. The instruction information includes the day of collection that is the date of collection of garbage in the predetermined region and information about the predetermined region.

(On-Board Terminal)

The on-board terminal 300 includes a controller 301, a display unit 302, and a communication unit 303. The controller 301 includes a function of performing arithmetic processing to control the on-board terminal 300. The controller 301 may be implemented by a processor of the on-board terminal 300. The communication unit 303 includes a function of connecting the on-board terminal 300 to the network N1. The communication unit 303 may be implemented by a communication I/F of the on-board terminal 300. The controller 301 receives the instruction information from the management server 200 by the communication unit 303.

The display unit 302 includes a function of displaying various pieces of information to an occupant of the collection vehicle 30. The display unit 302 may be implemented by a display device of the on-board terminal 300. The controller 301 causes the display unit 302 to display a collection instruction instructing collection of garbage in the predetermined region, based on the instruction information. The controller 301 causes the display unit 302 to display the day of collection and the information about the predetermined region that are included in the instruction information. The on-board terminal 300 may thereby urge the occupant of the collection vehicle 30 (the dispatch vehicle 30) to collect garbage in the predetermined region on the day of collection.

(Flow of Information/Processes)

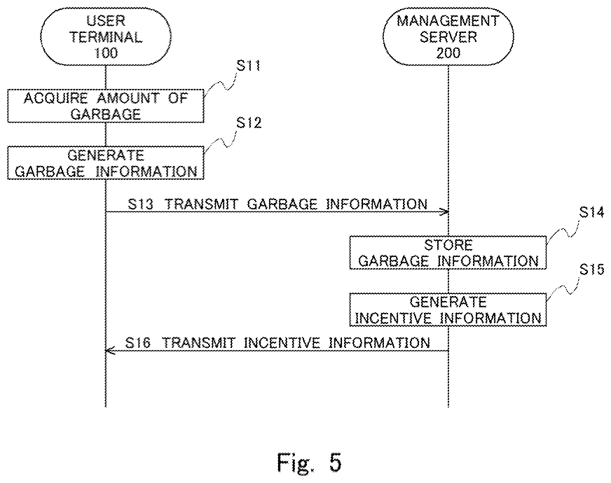

A description will be given, with reference to FIG. 5, of a flow of information between the user terminal 100 and the management server 200 and processes of the garbage collection system 1 according to the present embodiment. FIG. 5 is a first sequence diagram illustrating a flow of information and processes of the garbage collection system 1 according to the present embodiment. Processes that are performed by the user terminal 100 and the management server 200 are performed by the controller 101 and the controller 201, respectively.

With the garbage collection system 1, first, the user terminal 100 acquires the amount of garbage that the associated user wants collected in the predetermined region (S11). Next, the user terminal 100 generates the garbage information including the amount of garbage that is desired to be collected in the predetermined region (S12). Then, the user terminal 100 transmits the garbage information to the management server 200 (S13). The management server 200 receiving the garbage information stores the garbage information in the garbage information DB 203 (S14). Furthermore, the management server 200 generates the incentive information (S15). Then, the management server 200 transmits the incentive information to the user terminal 100 that transmitted the garbage information (S16). Additionally, the destination of transmission of the incentive information by the management server 200 in the process in S16 does not necessarily have to be the user terminal 100. For example, the controller 201 may transmit the incentive information to an external server that manages electronic coupons or points.

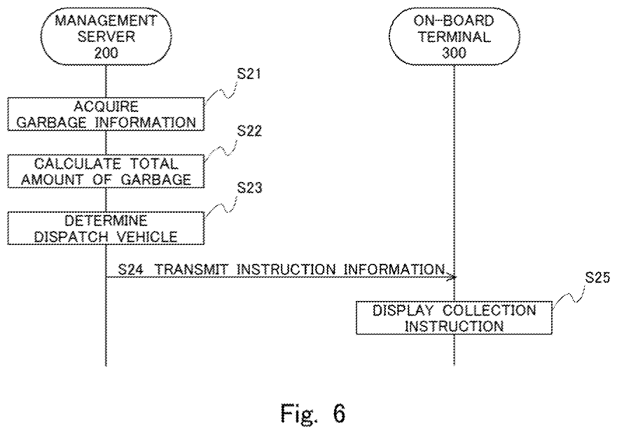

Next, a description will be given, with reference to FIG. 6, of a flow of information between the management server 200 and the on-board terminal 300 and processes of the garbage collection system 1 according to the present embodiment. FIG. 6 is a second sequence diagram illustrating a flow of information and processes of the garbage collection system 1 according to the present embodiment. Processes that are performed by the management server 200 and the on-board terminal 300 are performed by the controller 201 and the controller 301, respectively.

With the garbage collection system 1, first, the management server 200 acquires, from the garbage information DB 203, the garbage information received from each user terminal 100 (S21). Next, the management server 200 calculates the total amount of garbage in the predetermined region based on the garbage information acquired (S22). At this time, as described above, the management server 200 calculates the total amount of garbage in the predetermined region by also taking into account the amount of garbage that people other than the users want collected in the predetermined region. Next, the management server 200 determines at least one dispatch vehicle 30 based on the total amount of garbage in the predetermined region that is calculated and the collection vehicle information that is stored in the collection vehicle information DB 204 (S23). Then, the management server 200 transmits the instruction information to the on-board terminal 300 of the at least one dispatch vehicle 30 that is determined (S24). The on-board terminal 300 receiving the instruction information displays the collection instruction on the display unit 302 based on the instruction information (S25).

As described above, with the garbage collection system 1 according to the present embodiment, at least one dispatch vehicle 30 may be determined based on the total amount of garbage that is desired to be collected in the predetermined region. The collection vehicle 30 may thus be efficiently dispatched.

### Second Embodiment

In the first embodiment, the management server 200 calculates, as the total amount of garbage in the predetermined region, an amount including the total amount of garbage that people other than the users want collected. However, in a present embodiment, only the garbage of users who transmit the garbage information is taken as target of garbage collection by the collection vehicle 30 (that is, garbage of people other than users who transmit the garbage information is not included in the target of garbage collection). Accordingly, the management server 200 calculates, as the total amount of garbage in the predetermined region, the sum of the amount of garbage that users transmitting the garbage information want collected in the predetermined region. Furthermore, in the present embodiment, the management server 200 determines a collection route where the collection vehicle 30 is to travel to collect garbage at each collection point that is a location, in the predetermined region, where each user transmitting the garbage information wants garbage to be collected. The present embodiment is different from the first embodiment in that the collection vehicle 30 (the dispatch vehicle 30) collects only the garbage of each user transmitting the garbage information, according to the collection route. In the following, only differences from the first embodiment will be described.

Information about a location, in the predetermined region, where a user wants garbage to be collected (hereinafter sometimes referred to as “collection point”) is input to the input unit 102 of the user terminal 100, in addition to the amount of garbage that the user wants collected in the predetermined region. As the collection point, a garbage collection site, in the predetermined region, where the user wants garbage to be collected, a doorstep of the user, or the like may be cited, for example. Furthermore, as information about the collection point, an address of the collection point, coordinates (latitude and longitude) of the collection point, or the like may be cited, for example. The controller 101 acquires the collection point where the user wants garbage to be collected, based on the information about the collection point that is input to the input unit 102. Then, the controller 101 generates garbage information including the amount of garbage that the user wants collected in the predetermined region and the collection point, and transmits the garbage information to the management server 200 via the communication unit 104. Alternatively, the user terminal 100 may transmit the garbage information to the management server 200 by acquiring the position of the user terminal 100, instead of the information about the collection point being input to the input unit 102 by the user. At this time, the user terminal 100 acquires a current position of the user terminal 100 after acquiring the amount of garbage as in the first embodiment. The user terminal 100 may thereby acquire the information about the collection point, without the user inputting the information about the collection point to the input unit 102. Then, the user terminal 100 generates the garbage information based on the amount of garbage and the current position that are acquired, and transmits the garbage information to the management server 200.

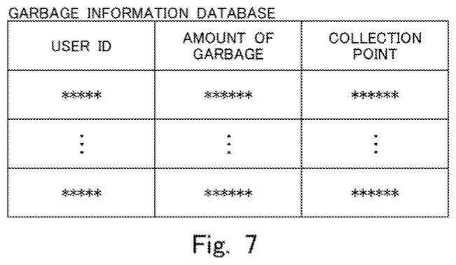

The controller 201 of the management server 200 stores the garbage information received from each user terminal 100 in the garbage information DB 203. FIG. 7 is a diagram illustrating an example of a table structure of the garbage information that is stored in the garbage information DB 203 according to the present embodiment. As illustrated in FIG. 7, the table for the garbage information includes a user ID field, a garbage amount field, and a collection point field. Information about the collection point where each user transmitting the garbage information wants garbage to be collected is input in the collection point field.

The controller 201 calculates the total amount of garbage in the predetermined region based on the amount of garbage that each user wants collected and that is stored in the garbage information DB 203. In the present embodiment, unlike in the first embodiment, the total amount of garbage in the predetermined region is calculated based on the sum of the amount of garbage that each user wants collected and that is stored in the garbage information DB 203. Then, the controller 201 determines at least one dispatch vehicle 30 based on the total amount of garbage in the predetermined region that is calculated. The method performed here by the controller 201 to determine the at least one dispatch vehicle 30 based on the total amount of garbage that is calculated is the same as the method in the first embodiment. Moreover, the controller 201 determines the collection route where the at least one dispatch vehicle 30 that is determined is to travel to collect garbage at each collection point, based on information about each collection point in the garbage information that is stored in the garbage information DB 203. Then, the controller 201 transmits route information including the collection route to the at least one dispatch vehicle 30 that is determined, together with the instruction information.

The on-board terminal 300 of the dispatch vehicle 30 displays the collection instruction and the collection route on the display unit 302, based on the instruction information and the route information received from the management server 200. An occupant of the dispatch vehicle 30 may thereby be urged to collect the garbage in the predetermined region, and may also grasp the collection route. Then, garbage may be collected at each collection point input by each user transmitting the garbage information, by the dispatch vehicle 30 traveling along the collection route.

(Flow of Information/Processes)

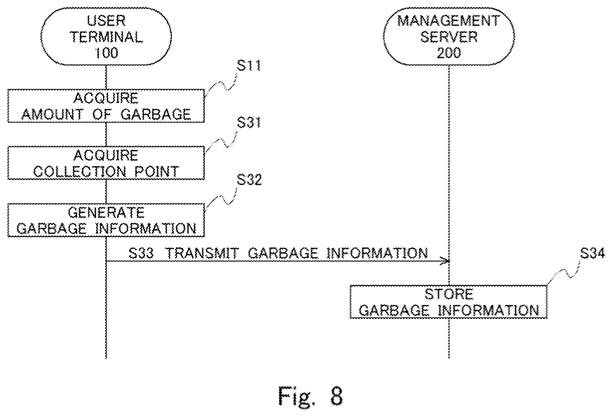

A description will be given, with reference to FIG. 8, of a flow of information between the user terminal 100 and the management server 200 and processes of the garbage collection system 1 according to the present embodiment. FIG. 8 is a third sequence diagram illustrating a flow of information and processes of the garbage collection system 1 according to the present embodiment.

With the garbage collection system 1, after the process in S11, the user terminal 100 acquires the collection point based on the collection point that is input to the input unit 102 by the user who is associated with the user terminal 100 (S31). Next, the user terminal 100 generates garbage information including the amount of garbage that the user wants collected in the predetermined region and the collection point (S32). Then, the user terminal 100 transmits the garbage information to the management server 200 (S33). The management server 200 stores the garbage information received from the user terminal 100 in the garbage information DB 203 (S34).

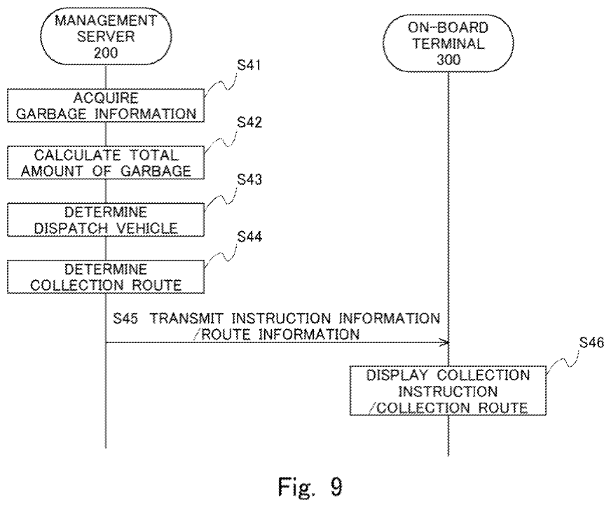

Next, a description will be given, with reference to FIG. 9, of a flow of information between the management server 200 and the on-board terminal 300 and processes of the garbage collection system 1 according to the present embodiment. FIG. 9 is a fourth sequence diagram illustrating a flow of information and processes of the garbage collection system 1 according to the present embodiment.

With the garbage collection system 1, first, the management server 200 acquires, from the garbage information DB 203, the garbage information that is received from each user terminal 100 (S41). Next, the management server 200 calculates the total amount of garbage in the predetermined region based on the garbage information that is acquired (S42). At this time, as described above, the management server 200 calculates the total amount of garbage in the predetermined region based on the sum of the amount of garbage that each user transmitting the garbage information wants collected in the predetermined region. Next, the management server 200 determines at least one dispatch vehicle 30 based on the total amount of garbage that is calculated (S43). Then, the management server 200 determines the collection route of the at least one dispatch vehicle 30 based on the information about the collection point included in the garbage information (S44). At this time, in a case where a plurality of collection vehicles 30 are determined as the dispatch vehicles 30, the management server 200 determines the collection route of each dispatch vehicle 30 in such a way that garbage may be appropriately collected by the plurality of dispatch vehicles 30 at each collection point specified by each user. For example, the management server 200 determines a travel route of each dispatch vehicle 30 such that each dispatch vehicle 30 may efficiently collect its assigned share of garbage. Then, the management server 200 transmits the route information to the on-board terminal 300 of the at least one dispatch vehicle 30 that is determined, together with the instruction information (S45). The on-board terminal 300 receiving the instruction information and the route information displays the collection instruction and the collection route on the display unit 302 (S46).

As described above, also with the garbage collection system 1 according to the present embodiment, at least one dispatch vehicle 30 may be determined based on the total amount of garbage that is desired to be collected in the predetermined region. Furthermore, with the garbage collection system 1 according to the present embodiment, the collection route of the at least one dispatch vehicle 30 may be determined based on the collection point, in the predetermined region, specified by each user. The dispatch vehicle 30 may thus collect garbage that each user transmitting the garbage information wants collected, along the collection route that enables efficient collection of garbage. In this way, efficient dispatch of the collection vehicle 30 may be also realized.

### Other Embodiments

The embodiments described above are merely examples, and the present disclosure may be changed and implemented as appropriate within the scope of the present disclosure. Furthermore, the processes and means described in the present disclosure may be freely combined and implemented to the extent that no technical conflict occurs.

Furthermore, a process that is described to be performed by one apparatus may be shared and performed by a plurality of apparatuses. Alternatively, processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the above embodiments to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions such as read-only memories (ROMs), random access memories (RAMs), EPROMs, EEPROMs, magnetic cards, flash memories, and optical cards.

What is claimed is:

1. A system comprising a plurality of user terminals associated with a plurality of users, and an information processing apparatus configured to manage a plurality of collection vehicles for collecting garbage, wherein
each user terminal transmits, to the information processing apparatus, garbage information including an amount of garbage that an associated user wants collected in a predetermined region, and
the information processing apparatus
calculates a total amount of garbage that is desired to be collected in the predetermined region, based on the garbage information received from each user terminal, and
determines at least one dispatch vehicle to be dispatched to the predetermined region from among the plurality of collection vehicles, based on the total amount of garbage that is calculated.

2. The system according to claim 1, wherein the information processing apparatus generates incentive information indicating an incentive that is given to a user who transmits the garbage information.

3. The system according to claim 1, wherein
the garbage information transmitted from each user terminal includes information about a collection point that is a location, in the predetermined region, where a corresponding user wants garbage to be collected, and
the information processing apparatus determines a collection route where the at least one dispatch vehicle is to travel to collect garbage at each collection point, based on information about each collection point received from each user terminal.

4. The system according to claim 1, wherein the user terminal acquires the amount of garbage based on information input to an input unit of the user terminal.

5. The system according to claim 1, wherein the user terminal acquires the amount of garbage based on an image or a moving image of garbage that an associated user wants collected in the predetermined region, the image or the moving image being captured by a capturing unit of the user terminal.

6. The system according to claim 1, wherein the information processing apparatus
includes a database that stores the garbage information received from each user terminal, and
calculates the total amount of garbage based on the garbage information that is received from each user terminal and stored in the database.

7. The system according to claim 1, wherein
the system further comprises an on-board terminal that is mounted on each collection vehicle,
the information processing apparatus transmits instruction information instructing collection of garbage in the predetermined region, to the on-board terminal mounted on the at least one dispatch vehicle, and
the on-board terminal mounted on the at least one dispatch vehicle displays, on a display unit of the on-board terminal, a collection instruction instructing collection of garbage in the predetermined region, based on the instruction information.

8. The system according to claim 3, wherein
the system further comprises an on-board terminal that is mounted on each collection vehicle,
the information processing apparatus transmits route information including the collection route to the on-board terminal mounted on the at least one dispatch vehicle, and
the on-board terminal mounted on the at least one dispatch vehicle displays the collection route on a display unit of the on-board terminal based on the route information.

9. An information processing apparatus that manages a plurality of collection vehicles for collecting garbage, the information processing apparatus comprising a controller comprising at least one processor configured to:
acquire garbage information including an amount of garbage that each of a plurality of users wants collected in a predetermined region,
calculate a total amount of garbage that is desired to be collected in the predetermined region, based on the garbage information on each of the plurality of users, and
determine at least one dispatch vehicle to be dispatched to the predetermined region from among the plurality of collection vehicles, based on the total amount of garbage that is calculated.

10. The information processing apparatus according to claim 9, wherein the controller is further configured to generate incentive information indicating an incentive that is given to a user who transmits the garbage information.

11. The information processing apparatus according to claim 9, wherein the controller is further configured to:
acquire the garbage information further including information about a collection point that is a location, in the predetermined region, where each of the plurality of users wants garbage to be collected, and
determine a collection route where the at least one dispatch vehicle is to travel to collect garbage at the collection point, based on information about the collection point from each of the plurality of users.

12. The information processing apparatus according to claim 9, wherein
the information processing apparatus includes a database that stores the garbage information on each of the plurality of users, and
the controller calculates the total amount of garbage based on the garbage information on each of the plurality of users that is stored in the database.

13. The information processing apparatus according to claim 9, wherein the controller is further configured to transmit instruction information instructing collection of garbage in the predetermined region, to an on-board terminal mounted on the at least one dispatch vehicle.

14. The information processing apparatus according to claim 11, wherein the controller is further configured to transmit route information including the collection route, to an on-board terminal mounted on the at least one dispatch vehicle.

15. An information processing method performed by a computer that manages a plurality of collection vehicles for collecting garbage, the information processing method comprising:
acquiring garbage information including an amount of garbage that each of a plurality of users wants collected in a predetermined region;
calculating a total amount of garbage that is desired to be collected in the predetermined region, based on the garbage information on each of the plurality of users; and
determining at least one dispatch vehicle to be dispatched to the predetermined region from among the plurality of collection vehicles, based on the total amount of garbage that is calculated.

16. The information processing method according to claim 15, further comprising generating incentive information indicating an incentive that is given to a user who transmits the garbage information.

17. The information processing method according to claim 15, further comprising:
acquiring the garbage information further including information about a collection point that is a location, in the predetermined region, where each of the plurality of users wants garbage to be collected; and
determining a collection route where the at least one dispatch vehicle is to travel to collect garbage at the collection point, based on information about the collection point from each of the plurality of users.

18. The information processing method according to claim 15, wherein the total amount of garbage is calculated based on the garbage information on each of the plurality of users that is stored in a database, in the computer, that stores the garbage information on each of the plurality of users.

19. The information processing method according to claim 15, further comprising transmitting instruction information instructing collection of garbage in the predetermined region, to an on-board terminal mounted on the at least one dispatch vehicle.

20. The information processing method according to claim 17, further comprising transmitting route information including the collection route, to an on-board terminal mounted on the at least one dispatch vehicle.
